(19) United States
(12) Patent Application Publication
(10) Pub. No.: US 2022/0215496 A1
(43) Pub. Date: Jul. 7, 2022

(54) DYNAMIC MESSAGE MANAGEMENT FOR PERSONAL PROTECTIVE EQUIPMENT

(71) Applicant: 3M INNOVATIVE PROPERTIES COMPANY, St. Paul, MN (US)

(72) Inventors: Britton G. Billingsley, St. Paul, MN (US); Claire R. Donoghue, Reading (GB); Andrew W. Long, Woodbury, MN (US); Benjamin W. Watson, Odiham (GB); Caroline M. Ylitalo, Stillwater, MN (US); Magnus S. Johansson, Jönköping (SE); Henning T. Urban, Värnamo (SE)

(21) Appl. No.: 17/594,230

(22) PCT Filed: Apr. 6, 2020
(86) PCT No.: PCT/IB2020/053283

§ 371 Date: Oct. 7, 2021

Related U.S. Application Data
(60) Provisional application No. 62/832,221, filed on Apr. 10, 2019.

(51) Int. Cl. G06Q 50/26

(52) U.S. Cl. CPC G06Q 50/265

(57) ABSTRACT

A system includes an article of personal protective equipment (PPE) associated with a first worker and at least one computing device. The article of PPE includes a display device. The at least one computing device configured to receive an indication of audio data from a second worker, the audio data including a message. The at least one computing device is also configured to determine a risk level for the first worker and determine whether to display a visual representation of the message. The at least one computing device is further configured to output the visual representation of the message for display by the display device.

### TECHNICAL FIELD

The present disclosure relates to industrial personal protective and safety equipment, such as respirators, self-contained breathing apparatuses, welding helmets, earmuffs, eyewear.

### BACKGROUND

Many work environments include hazards that may expose people working within a given environment to a safety event, such as hearing damage, eye damage, a fall, breathing contaminated air, or temperature related injuries (e.g., heat stroke, frostbite, etc.). In many work environments, workers may utilize personal protective equipment (PPE) to help mitigate the risk of a safety event. Communication between workers may increase the risk of a safety event, for example, by preventing the worker from focusing on a task.

### SUMMARY

In general, the present disclosure describes techniques for managing messages presented to workers in a work environment while the workers are utilizing personal protective equipment (PPE). According to examples of this disclosure, a computing device automatically computes and performs a safety risk assessment and dynamically determines whether to output messages to a worker that is currently utilizing PPE within a given work environment. In examples, the computing device determines whether to output a message audibly, visually, audibly and visually, or neither audibly nor visually. In some examples, the computing device computes a current risk level for the worker based on a number of factors to determine whether to output the message to the worker. The risk level for the worker may, for example, be indicative of a likelihood of the worker experiencing a safety event if presented with the message.

In one example, when the risk level for the worker is low, the computing device may visually output the message by outputting a graphical user interface (GUI) that includes at least a portion of the message via a display device, such that the worker may visually consume the content of the message. As another example, when the risk level for the worker is high, the computing device may refrain from visually outputting the message, such that the user may not visually consume the content of the message at that time. In such examples, the computing device may output the message audibly or may refrain from outputting the message altogether at that time. In some instances, the computing device determines whether to visually output the message based on the urgency of the message. As such, the computing device may determine an output modality (e.g., visual, audible, etc.) based on aspects such as the risk level, worker activity, type of PPE, work environment or hazards, or any other suitable context information. For instance, the computing device may output urgent messages (e.g., an alert of an imminent hazard) even when the worker is performing a task with a relatively high risk level. In another instance, the computing device may visually output non-urgent messages when the risk level is relatively low.

In this way, the computing device may determine a risk level for a worker and/or an urgency level of a message. The computing device may selectively output messages via a display device of the PPE device based on the risk level for the worker and/or urgency level of the message. By selectively outputting messages when the risk level is low and/or the urgency level is high, the computing device may reduce distractions to the worker. Reducing distractions to the worker may increase worker safety, for example, by enabling the worker to focus while performing dangerous tasks.

In one example, the disclosure describes a system that includes an article PPE associated with a first worker and at least one computing device. The article of PPE includes a display device. The at least one computing device is configured to receive an indication of audio data from a second worker, the audio data including a message; determine a risk level for the first worker; determine, based at least in part on the risk level, whether to display a visual representation of the message; and responsive to determining to display the visual representation of the message, output, for display by the display device, the visual representation of the message.

In another example, the disclosure describes an article of PPE that includes a display device and at least one computing device. The at least one computing device is configured to: receive an indication of audio data from a second worker, the audio data including a message; determine a risk level for the first worker; determine, based at least in part on the risk level, whether to display a visual representation of the message; and responsive to determining to display the visual representation of the message, output, for display by the display device, the visual representation of the message.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example system for managing worker communication in a work environment while workers are utilizing personal protective equipment, in accordance with various techniques of this disclosure.

FIG. 2 is a conceptual diagram illustrating example operations of an article of personal protective equipment, in accordance with various techniques of this disclosure.

FIG. 3 is a conceptual diagram illustrating an example article of personal protective equipment, in accordance with various techniques of this disclosure.

FIG. 4 is a conceptual diagram illustrating an example personal protective equipment management system, in accordance with various techniques of this disclosure.

FIG. 5 is a flowchart illustrating example operations of an example computing system, in accordance with various techniques of this disclosure.

It is to be understood that the embodiments may be utilized and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

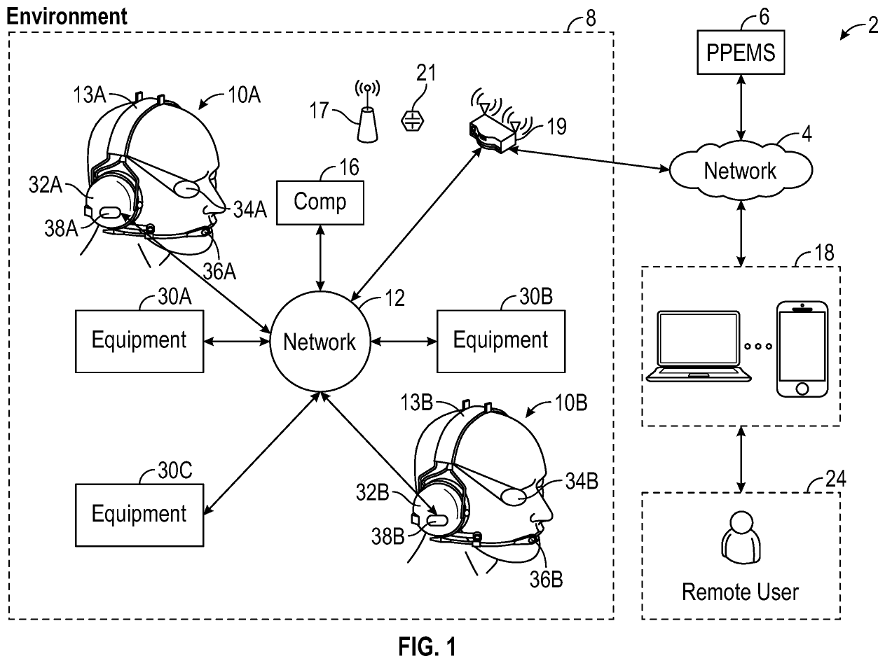

FIG. 1 is a block diagram illustrating an example system 2 for managing worker communication in a work environment while workers are utilizing personal protective equipment (PPE), according to techniques described in this disclosure. In the example of FIG. 1, environment 8 includes a plurality of workers 10A-10B (collectively, workers 10) utilizing PPE 13A-13B (collectively, PPE 13).

As shown in the example of FIG. 1, system 2 represents a computing environment in which computing device(s) within an environment 8 electronically communicate with one another and/or with personal protection equipment management system (PPEMS) 6 via one or more computer networks 4. PPEMS 6 may include distributed computing platform (e.g., a cloud computing platform executing on various servers, virtual machines and/or containers within an execution environment provided by one or more data centers), physical servers, desktop computing devices or any other type of computing system.

Environment 8 represents a physical environment, such as a work environment, in which one or more individuals, such as workers 10, utilize personal protective equipment 13 while engaging in tasks or activities within the respective environment. Examples of environment 8 include an industrial warehouse, a construction site, a mining site, a manufacturing site, among others.

As shown in this example, environment 8 may include one or more articles of equipment 30A-30C (collectively, equipment 30). Examples of equipment 30 may include machinery, industrial tools, robots, individual manufacturing lines or stages, among others. For example, equipment 30 may include HVAC equipment, computing equipment, manufacturing equipment, or any other type of equipment utilized within a physical work environment. Equipment 30 may be moveable or stationary.

In the example of FIG. 1, PPE 13 may include head protection. As used throughout this disclosure, head protection may refer to any type of PPE worn on the worker's head to protect the worker's hearing, sight, breathing, or otherwise protect the worker. Examples of head protection include respirators, welding helmets, visors, shields, earmuffs, eyewear, or any other type of PPE that is worn on a worker's head. As illustrated in FIG. 1, PPE 13A includes speakers 32A, display device 34A, and microphone 36A. Similarly, PPE 13B may include speakers 32B, display device 34B, and microphone 36B.

Each article of PPE 13 may include one or more output devices for outputting data that is indicative of operation of PPE 13 and/or generating and outputting communications to the respective worker 10. For example, PPE 13 may include one or more devices to generate audible feedback (e.g., speaker 32A or 32B, collectively “speakers 32”). As another example, PPE 13 may include one or more devices to generate visual feedback, such as display device 34A or 34B (collectively, “display devices 34”), light emitting diodes (LEDs) or the like. As yet another example, PPE 13 may include one or more device to generate tactile feedback (e.g., a device that vibrates or provides other haptic feedback).

Each article of PPE 13 is configured to communicate data, such as sensed motions, events and conditions, over network 12 via wireless communications, such as via a time division multiple access (TDMA) network or a code-division multiple access (CDMA) network, or via 802.11 WiFi® protocols, Bluetooth® protocol, Digital Enhanced Cordless Telecommunications (DECT), or the like. In some such examples, one or more of the PPEs 13 communicates directly with a wireless access point 19, and through wireless access point 19 to PPEMS 6.

In general, environment 8 may include computing facilities (e.g., a local area network) by which sensing stations 21, beacons 17, and/or PPE 13 are able to communicate with PPEMS 6. For examples, environments 8 may include network 12. In some examples, network 12 enables PPE 13, equipment 30, and/or computing devices 16 to communicate with one another and/or other computing devices (e.g., computing devices 18 or PPEMS 6). Network 12 may include one or more wireless networks, such as 802.11 wireless networks, 802.15 ZigBee networks, CDMA networks, TDMA networks, and the like. Environment 8 may include one or more wireless access points 19 to provide support for wireless communications. In some examples, environment 8 may include a plurality of wireless access points 19 that may be geographically distributed throughout the environment to provide support for wireless communications throughout the work environment.

As shown in the example of FIG. 1, environment 8 may include one or more wireless-enabled beacons 17 that provide location data within the work environment. For example, beacon 17 may be GPS-enabled such that a controller within the respective beacon may be able to precisely determine the position of the respective beacon. In some examples, beacons 17 may not be GPS-enabled. In such examples, beacon 17 and/or an article of PPE 13 may determine a location of the article of PPE 13 based on determining that beacon 17 and the article of PPE 13 are within proximity of one another. In some instances, beacon 17 and/or an article of PPE 13 may determine whether beacon 17 and article of PPE 13 are within proximity of one another using a short-range communication protocol such as BLUETOOTH®, RFID, Near-field communication (NFC), among others. Based on wireless communications with one or more of beacons 17, an article of PPE 13 is configured to determine the location of the worker within environment 8. In this way, event data reported to PPEMS 6 may be stamped with positional data to aid analysis, reporting and analytics performed by PPEMS 6.

In addition, environment 8 may include one or more wireless-enabled sensing stations 21. Each sensing station 21 includes one or more sensors and a controller configured to output environmental data indicative of sensed environmental conditions. Moreover, sensing stations 21 may be positioned within respective geographic regions of environment 8 or otherwise interact with beacons 17 to determine respective positions and include such positional data when reporting environmental data to PPEMS 6. As such, PPEMS 6 may be configured to correlate the sensed environmental conditions with the particular regions and, therefore, may utilize the captured environmental data when processing event data received from PPE 13 and/or sensing stations 21. For example, PPEMS 6 may utilize the environmental data to aid generating alerts or other instructions for PPE 13 and for performing predictive analytics, such as determining any correlations between certain environmental conditions (e.g., heat, humidity, visibility) with abnormal worker behavior or increased safety events. As such, PPEMS 6 may utilize current environmental conditions to aid prediction and avoidance of imminent safety events. Example environmental conditions that may be sensed by sensing stations 21 include but are not limited to temperature, humidity, presence of harmful gas, pressure, visibility, wind and the like. Safety events may refer to heat related illness or injury, cardiac related illness or injury, or eye or hearing related injury or illness, or any other events that may affect the health or safety of a worker.

In addition, environment 8 may include computing facilities that provide an operating environment for end-user computing devices 16 for interacting with PPEMS 6 via network 4. In one example, environment 8 may include one or more safety managers that may utilize computing devices 16, for example, to oversee safety compliance within the environment.

Remote users 24 may be located outside of environment 8. Users 24 may use computing devices 18 to interact with PPEMS 6 (e.g., via network 4) or communicate with workers 10. For purposes of example, computing devices 16, 18 may be laptops, desktop computers, mobile devices such as tablets or so-called smart phones, or any other type of device that may be used to interact or communicate with workers 10 and/or PPEMS 6.

Users 24 may interact with PPEMS 6 to control and actively manage many aspects of PPE 13 and/or equipment 30 utilized by workers 10, such as accessing and viewing usage records, analytics and reporting. For example, users 24 may review data acquired and stored by PPEMS 6. The data acquired and stored by PPEMS 6 may include data specifying task starting and ending times, changes to operating parameters of an article of PPE 13, status changes to components of an article of PPE 13 (e.g., a low battery event), motion of workers 10, environment data, and the like. In addition, users 24 may interact with PPEMS 6 to perform asset tracking and to schedule maintenance events for individual article of PPE 13 or equipment 30 to ensure compliance with any procedures or regulations. PPEMS 6 may allow users 24 to create and complete digital checklists with respect to the maintenance procedures and to synchronize any results of the procedures from computing devices 18 to PPEMS 6.

PPEMS 6 provides an integrated suite of personal safety protection equipment management tools and implements various techniques of this disclosure. That is, PPEMS 6 provides an integrated, end-to-end system for managing personal protection equipment, e.g., PPE, used by workers 10 within one or more physical environments 8. The techniques of this disclosure may be realized within various parts of system 2.

PPEMS 6 may integrate an event processing platform configured to process thousands or even millions of concurrent streams of events from digitally enabled devices, such as equipment 30, sensing stations 21, beacons 17, and/or PPE 13. An underlying analytics engine of PPEMS 6 may apply models to the inbound streams to compute assertions, such as identified anomalies or predicted occurrences of safety events based on conditions or behavior patterns of workers 10.

Further, PPEMS 6 may provide real-time alerting and reporting to notify workers 10 and/or users 24 of any predicted events, anomalies, trends, and the like. The analytics engine of PPEMS 6 may, in some examples, apply analytics to identify relationships or correlations between worker data, sensor data, environmental conditions, geographic regions and other factors and analyze the impact on safety events. PPEMS 6 may determine, based on the data acquired across populations of workers 10, which particular activities, possibly within certain geographic region, lead to, or are predicted to lead to, unusually high occurrences of safety events.

In this way, PPEMS 6 tightly integrates comprehensive tools for managing personal protective equipment with an underlying analytics engine and communication system to provide data acquisition, monitoring, activity logging, reporting, behavior analytics and alert generation. Moreover, PPEMS 6 provides a communication system for operation and utilization by and between the various elements of system 2. Users 24 may access PPEMS 6 to view results on any analytics performed by PPEMS 6 on data acquired from workers 10. In some examples, PPEMS 6 may present a web-based interface via a web server (e.g., an HTTP server) or client-side applications may be deployed for devices of computing devices 16, 18 used by users 24, such as desktop computers, laptop computers, mobile devices such as smartphones and tablets, or the like.

In accordance with techniques of this disclosure, articles of PPE 13A-13B may each include a respective computing device 38A-38B (collectively, computing devices 38) configured to manage worker communications while workers 10A-10B are utilizing PPE 13A-13B within work environment 8. Computing devices 38 may determine whether to output messages to one or more of workers 10 within work environment 8. Although shown as integrated within PPEs 13, computing devices 38 may be external to the PPEs and located within environment 8 (e.g., computing device 16) or located external to the work environment and reachable through network 4, such as PPEMS 6.

In the example of FIG. 1, each PPE 13 may enable communication with other workers 10 and/or remote users 24, for example, via speakers 32, display devices 34, and microphones 36. In one example, worker 10A may communicate with worker 10B and/or remote user 24. For example, microphone 36A may detect audio input (e.g., speech) from worker 10A. The audio input may include a message for worker 10B. In some instances, workers 10 may be engaged in a casual conversation or may be discussing work related information, such as working together to complete a task within work environment 8.

Computing device 38A receives audio data from microphone 36A, where the audio data includes a message. Computing device 38A outputs an indication of the audio data to another computing device, such as computing device 38B of PPE 13B, computing devices 16, 18, and/or PPEMS 6. In some instances, the indication of the audio data includes the audio data. For instance, computing device 38A may output an analog signal that includes the audio data. In another instance, computing device 38A may encode the audio data into a digital signal and outputs the digital signal to computing device 38B. In some examples, the indication of the audio data includes text indicative of the message. For example, computing device 38A may perform natural language processing (e.g., speech recognition) to convert the audio data to text, such that computing device 38A may output a data signal that includes a digital representation of the text. In some scenarios, computing device 38A outputs a graphical user interface that includes the text prior to sending the indication of the audio data to computing device 38B, which may allow worker 10A to verify the accuracy of the text prior to sending.

Computing device 38B receives the indication of the audio data from computing device 38A. Computing device 38B may determine whether to output a representation (e.g., visual, audible, or tactile representation) of the message included in the audio data. A visual representation of the message may include text or an image (a picture, icon, emoji, gif, or other image). In some examples, computing device 38B determines whether to output a visual representation of the message based at least in part on a risk level for worker 10B, an urgency level of the message, or both.

In some examples, computing device 38B determines a risk level for worker 10B based at least in part on worker data associated with worker 10B, task data associated with a task performed by worker 10B, sensor data, event data associated with PPE 13B utilized by worker 10B, or a combination thereof. The computed risk level for the worker may indicate a predicted likelihood, based on any and/or combinations of these factors, of the worker experiencing a safety event if presented with the visual representation at that time. Worker data may include data indicative of biographical characteristics of the worker (e.g., age, health information, etc.), a training level or experience level of the worker, an amount of time the worker has been working that day or shift, or any other data associated with the worker. Task data may include data indicating one or more tasks performed by the worker, such as a type of the task, a location of the task, a complexity of the task, a severity of harm to the worker, a likelihood of harm to the worker, and/or a duration of the task. Sensor data may include current physiological data indicative of physiological conditions of the worker, environmental data indicating environmental characteristics of environment 8, or both.

As described herein, the complexity of a task may refer to a degree of difficulty of the task. For example, computing device 38B may determine a welding task is relatively complex and may determine a painting task is relatively simple. The severity of harm may refer to an amount of harm the worker is likely to experience if the worker experiences a particular safety event associated with the task. In other words, the severity of harm may to the worker may be associated with a particular safety event associated with a given task. For instance, safety events associated with working on scaffolding or otherwise working at height may include falling, vertigo, or both. Computing device 38B may determine the severity of harm to the worker for a fall is relatively high while the severity of harm to the worker for vertigo is relatively low. Similarly, safety events associated with working with chemicals may include a chemical burn, skin or eye irritation, or both. Computing device 38B may determine the severity of a chemical burn is relatively high and that the severity of skin or eye irritation is relatively low. As used herein, the likelihood of harm to the worker may refer to a probability of a worker experiencing a safety event. In some instances, the likelihood of harm may represent the aggregate probability of the worker experiencing any safety event. In another instance, each task and/or safety event is associated with a respective likelihood of harm.

In one scenario, computing device 38B determines the risk level for worker 10B based one or more rules. The rules may be pre-programmed or trained, for instance, via machine learning. Computing device 38B may determine the risk level for worker 10B by applying one or more rules to worker data associated with worker 10B, task data associated with a task performed by worker 10B, event data associated with PPE 13B utilized by worker 10B, and/or sensor data. In one example, computing device 38B may apply the rules to a type of task performed by worker 10B and outputs a risk level for worker 10B. For instance, computing device 38B may determine the risk level for worker 10B is relatively high (e.g., 80 out of 100) when the worker is performing a welding task. In another instance, computing device 38B may determine the risk level for worker 10B is relatively low (e.g., 20% out of 100) when the worker is painting. As another example, computing device 38B may apply the rules to sensor data indicative of physiological conditions of worker 10B and output a risk level for worker 10B. For example, computing device 38B may determine the risk level is relatively high when the worker is breathing relatively hard (e.g., above a threshold breathing rate) or has a relatively high heart rate (e.g., above a threshold heart rate).

Computing device 38B, in some examples, determines whether to output a visual representation of the message based at least in part on the risk level for the worker. For example, computing device 38B may determine whether the risk level satisfies a threshold risk level. In such examples, computing device 38B may determine to output the representation of the message in response to determining the risk level for the worker does not satisfy (e.g., is less than) the threshold risk level. Outputting the visual representation of the message may enable worker 10B to receive communications from other workers 10 or remote users 24, for example, when doing so is not likely to distract worker 10B or otherwise increase the risk of a safety event. In another example, computing device 38B may determine to refrain from outputting the message in response to determining the risk level satisfies (e.g., is greater than or equal to) the threshold risk level. Refraining from outputting the visual representation of the message may reduce the risk of a safety event, for example, by reducing the risk that worker 10B will be distracted by the message when he or she should be focusing on the task he or she is performing.

Computing device 38B may determine an urgency level of the message. In some instances, the data signal received from computing device 38A includes metadata for the message. The metadata may include data indicating an urgency level of the message, a sender of the message, a location of the sender, a timestamp, among other data. In one example, a user of computing device 38A specifies the urgency level such that computing device 38A indicates the urgency level of the message in the metadata. In another example, computing device 38A may determine the urgency level and may indicate the urgency level of the message in the metadata.

In some examples, computing device 38A determines the urgency level of the message based on physiological conditions of the sender (e.g., worker 10A). For example, computing device 38A may assign the urgency level of the message based on the sender's (worker 10A) heart rate and/or breathing rate. For example, high heart rates and/or breathing rates may indicate worker 10A is distressed or in-danger. Similarly, low heart rates and/or breathing rates may indicate worker 10A is distressed or in-danger. In some examples, computing device 38A may assign higher urgency levels as worker 10A's heart rate and/or breathing rate increase or decrease outside of a threshold range of heart rates and breathing rates, respectively.

Computing device 38A or 38B may determine the urgency level of the message based on the audio characteristics of the audio data. The audio characteristics of the audio data may include a tone, frequency, and/or decibel level of the audio data. In some examples, the audio data may be defined by one set of audio characteristics when worker 10A is stressed or panicked and may be defined by another set of audio characteristics when worker 10A is calm or relaxed. In one example, computing device 38B may assign one urgency level (e.g., “urgent”, or 80 out of 100) based on the first set of audio characteristics and a different urgency level (e.g., “normal”, or 40 out of 100) based on the second set of audio characteristics. Similarly, computing device 38A may determine the urgency level of the message based on the audio characteristics and may include an indication of the urgency level in the metadata.

Computing device 38A or computing device 38B may determine the urgency level of the message based on the content of the message. For example, computing device 38A or computing device 38B may perform natural language processing (e.g., speech recognition) on the audio data to determine the content of the message. The content may indicate a request for assistance, a type of assistance requested, the task being performed by the sender, the location of the sender or a location of the task to be performed, a safety hazard (e.g., fire, dangerous weather, etc.), or other a combination thereof. For instance, computing device 38B may determine the message includes one or more keyword words indicating a request for assistance and may assign a relatively high urgency level to the message.

As yet another example, computing device 38A or 38B may determine the urgency level of the message based on user data associated with the sender (e.g., worker 10A), such as an identity of the sender or a location of the sender. For example, computing device 38B may determine (e.g., based on the metadata) that the sender is not located within work environment 8 and may assign a relatively low urgency level to the message. In this way, computing device 38B may prioritize messages from workers in the same area or who are likely to be performing similar tasks. As another example, computing device 38B may assign the urgency level based on the identity of the sender. For example, computing device 38B may assign a relatively high urgency level to messages from certain users (e.g., a supervisor of worker 10B, such as user 24) and may assign a lower urgency level to messages from worker 10A (in comparison to messages from user 24).

Computing device 38B determines whether to output a visual representation of the message based at least in part on the risk level for the worker, the urgency level of the message, or both. Computing device 38B may determine whether the risk level for the worker satisfies a threshold risk level. In one example, computing device 38B outputs the visual representation of the message in response to determining that the risk level for the worker does not satisfy (e.g., is less than) a threshold risk level. For instance, computing device 38B may infer that displaying a visual representation of a message is not likely to increase the risk of worker 10B experiencing a safety event when the risk level is less than the threshold risk level, such that the visual representation of the message (e.g., text, an icon, etc.) can safely be displayed. In another example, computing device 38B may refrain from outputting a visual representation of the message in response to determining that the risk level for the worker satisfies (e.g., is greater than or equal to) the threshold risk level. In this way, computing device 38B may dynamically manage the information output to worker 10B to improve worker safety by refraining from potentially distracting the worker when the risk to the worker safety is relatively high.

Computing device 38B may determine whether the urgency level for the message satisfies a threshold urgency level. In some examples, computing device 38B outputs the visual representation of the message in response to determining that the urgency level for the message satisfies (e.g., is greater than or equal to) a threshold urgency level. In another example, computing device 38B may refrain from outputting a visual representation of the message in response to determining that the urgency level for the message does not satisfy (e.g., is less than) the threshold urgency level. In this way, computing device 38B may dynamically output information to worker 10B to improve worker safety by outputting urgent messages while refraining outputting less urgent messages.

Computing device 38B may determine whether to output the visual representation of the message based on the risk level for the worker and the urgency level for the message. In some examples, computing device 38B may compare the urgency level of the message to different threshold urgency levels and/or compare the risk level to different risk levels. In one example, when computing device 38B determines the risk level for the worker is a first risk level (e.g., “high”), computing device 38B may compare the urgency level to a first urgency level to determine whether to output the visual representation of the message. For example, when the risk level is “high”, computing device 38B may output a visual representation of the message when the urgency level of the message is, for example, “life threatening,” and may refrain from a visual representation of the message for all other (e.g., lower, less urgent) messages. In another example, when computing device 38B determines the risk level for the worker is a different risk level (e.g., “medium”), computing device 38B may compare the urgency level to a second urgency level to determine whether to output the visual representation of the message. For example, computing device 38B may output visual representations of messages with an urgency level of, for example, “important,” “very important,” or “life threatening,” when the risk level for worker 10B is, for example, “medium.”

Responsive to determining to output the visual representation of the message, computing device 38B may cause display device 34B to display the visual representation of the message. For instance, computing device 38B may cause display device 34B to output a graphical user interface that includes the visual representation of the message. The visual representation may include text, an icon, an emoji, a GIF, or other visually detectable representation of the message.

Computing device 38B may determine whether to output an audible representation of the message in a manner similar to determining whether to output a visual representation of the message. In one example, audible messages may be less distracting to the worker, such that computing device 38B may output an audible representation of a message when the risk level for the worker is relatively high while refraining from outputting a visual representation of the message at the same risk level. Responsive to determining to output the audible representation of the message, computing device may cause speaker 32B to output the audible representation of the message.

Computing device 38B may receive a message from one or more articles of equipment 30, one or more sensing stations 21, PPEMS 6, or a combination thereof, and determine whether to output a representation of the message. The message may include a flag or metadata indicating an urgency of the message.

In one example, computing device 38B receives a message from sensing station 21 where the message includes information indicative of one or more environmental hazards within environment 8. Computing device 38B may determine an urgency level of the message from sensing station 21. For example, the message may indicate levels of environmental characteristics of the work environment, such as the temperature, harmful gas concentration levels, sound decibel levels, among others. Computing device 38B may compare the levels of the environmental characteristics to one or more thresholds associated with the environmental characteristics to determine the urgency level of the message. For instance, computing device 38B may determine the urgency level of the message is “high” in response to determining harmful gas levels are above a safety threshold. Computing device 38B may compare the urgency level of the message to a threshold urgency level to determine whether to output a representation (e.g., audible, visual, tactile) of the message to worker 10B. Additionally or alternatively, in some instances, computing device 38B may determine whether to output a representation of the message from sensing stations 21 based on the risk level for the worker, as described above.

Computing device 38B may determine an urgency level of a message received from equipment 30 to determine whether to output a representation of the message from equipment 30. For example, the message may indicate characteristics of the article of equipment 30, such as a health status of the equipment (e.g., “normal”, “malfunction”, “overheating”, among others), usage status (e.g., indicative of battery life, filter life, oxygen levels remaining, among others), or any other information about the operation of equipment 30. Computing device 38B may compare the characteristics to one or more thresholds associated with the characteristics to determine the urgency level of the message. For instance, computing device 38B may determine the message is “urgent” in response to remaining oxygen left in an oxygen tank for a respirator is less than a safety threshold. Computing device 38B may compare the urgency level of the message to a threshold urgency level to determine whether to output a representation (e.g., audible, visual, tactile) of the message to worker 10B. Additionally or alternatively, in some instances, computing device 38B may determine whether to output a representation of the message from equipment 30 based on the risk level for the worker, as described above.

In this way, a computing device 38 may selectively output messages to a worker 10 based on the urgency level of the message and/or a risk level for the worker. Selectively outputting messages may reduce the risk of distracting a worker (e.g., a worker performing a dangerous task). Reducing distractions to the worker may increase worker safety.

While computing device 38 is described as managing communications between workers 10, in some examples, PPEMS 6 may include all or a subset of the functionality of computing device 38. For example, PPEMS 6 may determine a risk level for the worker and/or an urgency level of the message. PPEMS 6 may determine whether to output a representation of the message to the worker based on the risk level and/or urgency level. In some examples, PPEMS 6 may cause an article of PPE 13 to output a visual representation of the message, for example, by outputting a command to the article of PPE 13 to display a GUI that includes at least a portion of the message. In one example, PPEMS 6 may determine to refrain from outputting the representation of the message. In such examples, PPEMS 6 may refrain from outputting the command to the article of PPE 13 or may output a command causing the article of PPE 13 to refrain from outputting the representation of the message.

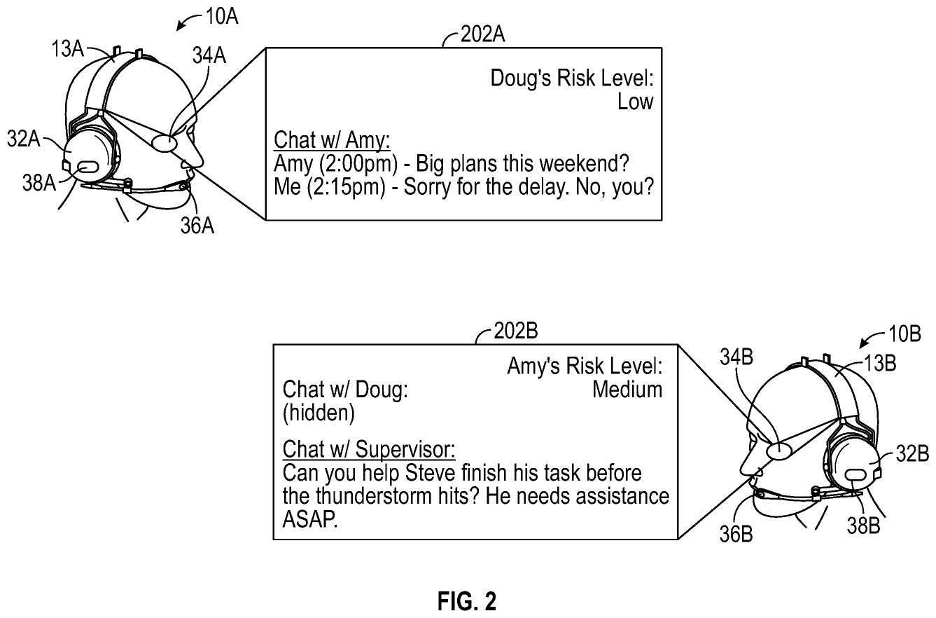

FIG. 2 is a conceptual diagram illustrating example operations of an article of personal protective equipment, in accordance with various techniques of this disclosure. In the example of FIG. 2, workers 10 may communicate with one another while utilizing PPE 13.

Worker 10B (e.g., Amy) may speak a first message (e.g., “Big plans this weekend?”) to worker 10A (e.g., Doug). Microphone 36B may detect audio input (e.g., the words spoken by worker 10B) and may generate audio data that includes the message. Computing device 38B may output an indication of the audio data to computing device 38A associated with worker 10A. The indication of the audio data may include an analog signal that includes the audio data, a digital signal encoded with the audio data, or text indicative of the first message.

Computing device 38A may determine a risk level for worker 10A. In the example of FIG. 2, computing device 38A determines the risk level for worker 10A is “Low”. Computing device 38A may determine whether to display a visual representation of the first message from worker 10B based at least in part on the risk level for worker 10A. For example, computing device 38A may determine the risk level for worker 10A does not satisfy (e.g., is less than) a threshold risk level. In the example of FIG. 2, computing device 38A determines to output a visual representation of the first message in response to determining the risk level for worker 10A does not satisfy the threshold risk level. For example, computing device 38A may cause display device 34A to display graphical user interface 202A. Graphical user interface 202A may include a text representation of the first message. In some examples, graphical user interface 202A includes a visual representation of the second message. For example, graphical user interface 202 may include message grouped by the parties involved in the communication (e.g., sender, recipient), topic, etc.

After receiving the first message, microphone 36A may detect a second message spoken by worker 10A (e.g., “Sorry for the delay. No, you?”) and may generate audio data that includes the second message. Computing device 38A may receive the audio data from microphone 36A and output an indication of the audio data to computing device 38B.

Computing device 38B may determine whether to output a visual indication of the second message based at least in part on a risk level for worker 10B. In the example of FIG. 2, computing device 38B determines the risk level for worker 10B is “Medium”. In some examples, computing device 38B determines to refrain from outputting a visual representation of the second message in response to determining the risk level for worker 10B satisfies (e.g., is greater than or equal to) the threshold risk level.

Computing device 38B may receive an indication of audio data that includes a third message. For instance, computing device 38B may receive the third message from remote user 24 of FIG. 1 (e.g., a supervisor of worker 10B). In some examples, computing device 38B determines whether to output a visual representation of the third message based at least in the risk level for worker 10B and an urgency level for the third message. In the example of FIG. 2, computing device 38B may determine the urgency level for the third message is “Medium”. Computing device 38B may determine a threshold risk level for worker 10B based at least in part on the urgency level of the third message. For example, computing device 38B may determine the threshold urgency level associated with worker 10B's current risk level is a “Medium” urgency level. In such examples, computing device 38B may compare the urgency level for the third message to the threshold urgency level. Computing device may determine to output the visual representation of the third message in response to determining the urgency level for the third message satisfies (e.g., is equal to or greater than) the threshold urgency level. For example, computing device 38B may output the visual representation of the third message by causing display device 34B to output a graphical user interface 202B that includes a representation of the third message. In some instances, as shown in FIG. 2, graphical user interface 202B includes a text representation of the third message. In another instance, graphical user interface 202B may include an image representing the third message (e.g., the visual representation may include an icon such as a storm-cloud when the third message includes information about an impending thunderstorm).

In some examples, the third message includes an indication of a task associated with another worker (e.g., Steve). In the example of FIG. 2, the third message indicates that Steve is performing a task. In such examples, computing device 38B may output, for display, data associated with the third message. In some instances, the data associated with the third image includes a map indicating a location of the task, one or more articles of PPE associated with the task, one or more articles of equipment associated with the task, or a combination thereof. In other words, in one example, graphical user interface 202B may include a map indicating a location of the task performed by another worker, one or more articles of PPE associated with that task, and/or one or more articles of equipment associated with that task.

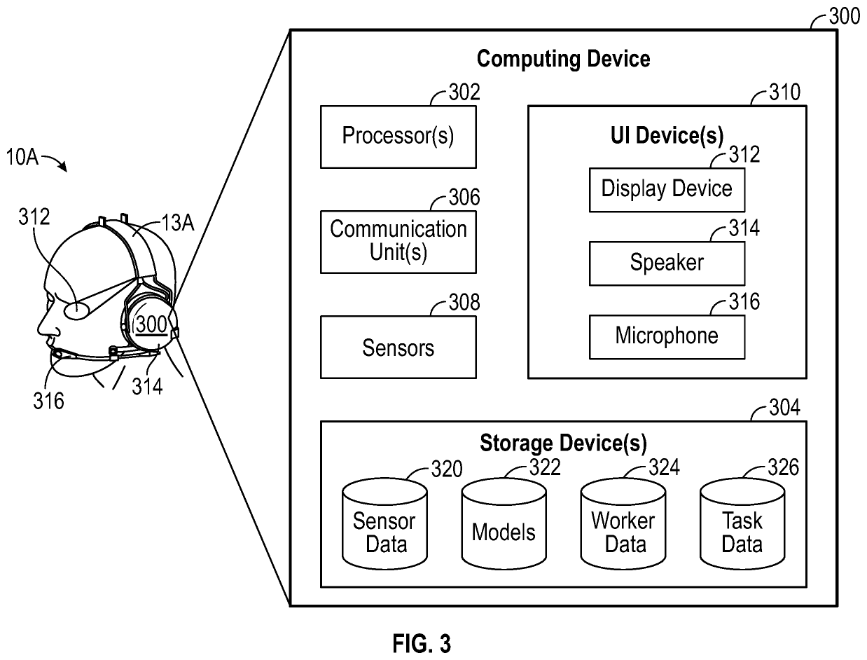

FIG. 3 is a conceptual diagram illustrating an example PPE that includes a computing device, in accordance with aspects of this disclosure. PPE 13A includes head protection that is worn on the worker's head to protect the worker's hearing, sight, breathing, or otherwise protect the worker. In the example of FIG. 3, PPE 13A includes computing device 300. Computing device 300 may be an example of computing devices 38 of FIG. 1.

Computing device 300 includes one or more processors 302, one or more storage devices 304, one or more communication units 306, one or more sensors 308, one or more user interface (UI) devices 310, sensor data 320, models 322, worker data 324, and task data 326. Processors 302, in one example, are configured to implement functionality and/or process instructions for execution within computing device 300. For example, processors 302 may be capable of processing instructions stored by storage device 304. Processors 302 may include, for example, microprocessors, digital signal processors (DSPs), application specific integrated circuits (ASICs), field-programmable gate array (FPGAs), or equivalent discrete or integrated logic circuitry.

Storage device 304 may include a computer-readable storage medium or computer-readable storage device. In some examples, storage device 304 may include one or more of a short-term memory or a long-term memory. Storage device 304 may include, for example, random access memories (RAM), dynamic random access memories (DRAM), static random access memories (SRAM), magnetic hard discs, optical discs, flash memories, or forms of electrically programmable memories (EPROM) or electrically erasable and programmable memories (EEPROM).

In some examples, storage device 304 may store an operating system or other application that controls the operation of components of computing device 300. For example, the operating system may facilitate the communication of data from electronic sensors 308 to communication unit 306. In some examples, storage device 304 is used to store program instructions for execution by processors 302. Storage device 304 may also be configured to store information within computing device 300 during operation.

Computing device 300 may use one or more communication units 306 to communicate with external devices via one or more wired or wireless connections. Communication units 306 may include various mixers, filters, amplifiers and other components designed for signal modulation, as well as one or more antennas and/or other components designed for transmitting and receiving data. Communication units 306 may send and receive data to other computing devices using any one or more suitable data communication techniques. Examples of such communication techniques may include TCP/IP, Ethernet, Wi-Fi®, Bluetooth®, 4G, LTE, DECT, to name only a few examples. In some instances, communication units 306 may operate in accordance with the Bluetooth Low Energy (BLU) protocol. In some examples, communication units 306 may include a short-range communication unit, such as an RFID reader.

Computing device 300 includes one or more sensors 308. Examples of sensors 308 include a physiological sensor, an accelerometer, a magnetometer, an altimeter, an environmental sensor, among other examples. In some examples, physiological sensors include a heart rate sensor, breathing sensor, sweat sensor, etc.

UI device 310 may be configured to receive user input and/or output information, also referred to as data, to a user. One or more input components of UI device 310 may receive input. Examples of input are tactile, audio, kinetic, and optical input, to name only a few examples. For example, UI device 310 may include a mouse, keyboard, voice responsive system, video camera, buttons, control pad, microphone 316, or any other type of device for detecting input from a human or machine. In some examples, UI device 310 may be a presence-sensitive input component, which may include a presence-sensitive screen, touch-sensitive screen, etc.

One or more output components of UI device 310 may generate output. Examples of output are data, tactile, audio, and video output. Output components of UI device 310, in some examples, include a display device 312 (e.g., a presence-sensitive screen, a touch-screen, a liquid crystal display (LCD) display, a Light-Emitting Diode (LED) display, an optical head-mounted display (HMD), among others), a light-emitting diode, a speaker 314, or any other type of device for generating output to a human or machine. UI device 310 may include a display, lights, buttons, keys (such as arrow or other indicator keys), and may be able to provide alerts or otherwise provide information to the user in a variety of ways, such as by sounding an alarm or vibrating.

According to aspects of this disclosure, computing device 300 may be configured to manage worker communications while a worker utilizes an article of PPE that includes computing device 300 within a work environment. For example, computing device 300 may determine whether to output a representation of one or more messages to worker 10A.

Computing device 300 receives an indication of audio data from a computing device, such as computing devices 38, PPEMS 6, or computing devices 16, 18 of FIG. 1. Computing device 300 may determine whether to output a representation (e.g., visual, audible, or tactile representation) of the message. In some examples, computing device 300 determines whether to output a visual representation of the message based at least in part on a risk level for worker 10A and/or an urgency level of the message.

Computing device 300 may determine the risk level for worker 10A and/or the urgency level for the message based on one or more rules. In some examples, the one or more rules are stored in models 322. Although other technologies can be used, in some examples, the one or more rules are generated using machine learning. In other words, storage device 304 may include executable code generated by application of machine learning. The executable code may take the form of software instructions or rule sets and is generally referred to as a model that can subsequently be applied to data, such as sensor data 320, worker data 324, and/or task data 326.

Example machine learning techniques that may be employed to generate models 322 can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbor (kNN), Learning Vector Quantization (LUQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

Models 322 include, in some example, separate models for individual workers, a population of workers, a particular environment, a type of PPE, a type of task, or combinations thereof. Computing device 300 may update models 322 based on additional data. For example, computing device 300 may update models 322 for individual workers, a population of workers, a particular environment, a type of PPE, or combinations thereof based on data received from PPE 13, sensing stations 21, or both.

Computing device 300 may apply one or more models 322 to sensor data 320, worker data 324, and/or task data 326 to determine a risk level for worker 10A. In one example, computing device 300 may apply models 322 to a type of task performed by worker 10A and outputs a risk level for worker 10A. As another example, computing device 300 may apply models 322 to sensor data 320 indicative of physiological conditions of worker 10A and output a risk level for worker 10A. For example, computing device 300 may apply models 322 to physiological data generated by sensors 308 to determine the risk level is relatively high when physiological data indicates the worker is breathing relatively hard or has a relatively high heart rate (e.g., above a threshold heart rate). As another example, computing device 300 may apply models 322 to worker data 324 and output a risk level for worker 10A. For example, computing device 300 may apply models 322 to worker data 324 to determine the risk level is relatively low when worker 10A is relatively experienced and determine the risk level is relatively high when worker 10A is relatively inexperienced.

In yet another example, computing device 300 applies models 322 to sensor data 320 and task data 326 to determine the risk level for worker 10A. For example, computing device 300 may apply models 322 to sensor data 320 indicative of environmental characteristics (e.g., decibel levels of the ambient sounds in the work environment) and task data 326 (e.g., indicating a type of task, a location of a task, a duration of a task) to determine the risk level. For instance, computing device 300 may determine the risk level for worker 10A is relatively high when the task involves dangerous equipment (e.g., sharp blades, etc.) and the noise in the work environment is relatively loud.

Computing device 300 may apply one or more models 322 to determine an urgency level of the message. In one example, computing device 300 applies models 322 to the audio characteristics of the audio data to determine the urgency level of the message. For example, computing device 300 may apply models 322 to the audio characteristics to determine that the audio characteristics of the audio data indicate the sender is afraid, such that computing device 300 may determine the urgency level for the message is high.

Computing device 300 may determine the urgency level of the message based on the content of the message and/or metadata for the message. For example, computing device 300 may perform natural language processing (e.g., speech recognition) on the audio data to determine the content of the message. In one example, computing device 300 may perform determine the content of the message and apply one or more of models 322 to the content to determine the urgency level of the message. For example, computing device 300 may determine the content of the message includes casual conversation and may determine based on applying models 322 that the urgency level for the message is low. As another example, computing device 300 applies models 322 to data metadata for the message (e.g., data indicating the sender of the message) and determines the urgency level for the message based on the metadata.

Computing device 300, in some examples, determines whether to output a visual representation of the message based at least in part on the risk level for the worker, the urgency level of the message, or both. For example, computing device 300 may determine whether the risk level satisfies a threshold risk level. In such examples, computing device 300 may determine to output the representation of the message in response to determining the risk level for the worker does not satisfy (e.g., is less than) the threshold risk level. In another example, computing device 300 may determine to refrain from outputting the representation of the message in response to determining the risk level satisfies (e.g., is greater than or equal to) the threshold risk level.

In some scenarios, computing device 300 determines to output the representation of the message in response to determining that the urgency level for the message satisfies (e.g., is greater than or equal to) a threshold urgency level. The representation of the message may include a visual representation of the message, an audible representation of the message, a haptic representation of the message, or a combination therein. In one instance, computing device 300 may output a visual representation of the message via display device 312. In another instance, computing device 300 outputs an audible representation of the message via speaker 314. In one example, computing device 300 may determine to refrain from outputting a representation of the message in response to determining that the urgency level for the message does not satisfy (e.g., is less than) the threshold urgency level.

In some examples, computing device outputs the representation of the message as a visual representation in response to determining to output the representation of the message. In one example, computing device 300 determines whether the representation of the message should be a visual representation, an audible representation, or a haptic representation, or a combination thereof. In other words, computing device 300 may determine a type (e.g., audible, visual, haptic) of the output that represents the message.

Computing device 300 may determine the type of the output based on the components of PPE 13A. In one example, computing device 300 determines the type of output includes an audible output in response to determining that computing device 300 includes speaker 314. Additionally or alternatively, computing device 300 may determine that the type of output includes a visual output in response to determine the computing device 300 includes display device 312. In this way, computing device 300 may output an audible representation of the message, a visual representation of the message, or both.

In some scenarios, computing device 300 determines a type of output based on the risk level of worker 10A and/or the urgency level of the message. In one scenario, computing device 300 compares the risk level to one or more threshold risk levels to determine the type of output. For example, computing device 300 may determine the type of output includes a visual output in response to determining that the risk level for worker 10A includes a “medium” threshold risk level and determine the type of output includes an audible risk level in response to determining the risk level includes a “high” threshold risk level. In other words, in one example, computing device 300 may output a visual representation of the message when the risk level for the worker is relatively low or medium risk. In examples where the risk level is relatively high, computing device 300 may output an audible representation of the message and may refrain from outputting a visual representation of the message.

In some examples, computing device 300 may store one or more received messages. For example, computing device 300 may store a message in response to determining to refrain from outputting a representation of the level. As one example, computing device 300 may store the message when the risk level for the worker satisfies the threshold risk level. In some instances, computing device 300 may output a representation of the message at a later time, for example, in response to determining the risk level for the worker does not satisfy the threshold risk level. For instance, computing device 300 may enable the worker to check stored messages and may output a visual, audible, and/or haptic representation of the message in response to receiving a user input to output one or more stored messages.

Computing device 300 may receive a message from a sensing station 21 of FIG. 1, PPEMS 6 of FIG. 1, computing devices 16, 18 of FIG. 1, equipment 30 of FIG. 1, or other device. Computing device 300 may determine whether to output a representation of the message based on an urgency of the message and/or the risk level for worker 10A. For instance, computing device 300 may determine an urgency level of the message in a manner similar to determining the urgency level for messages received from other workers 10. As one example, computing device 300 may determine whether to output a representation of a message received from an article of equipment 30 based on the urgency level of the message. The message may include data indicating characteristics of the article of equipment 30, such as a health status of the equipment (e.g., “normal”, “malfunction”, “overheating”, among others), usage status (e.g., indicative of battery life, filter life, oxygen levels remaining, among others), or any other information about the operation of equipment 30. Computing device 300 may compare the characteristics to one or more thresholds associated with the characteristics to determine the urgency level of the message. Computing device 300 may output a representation of the message in response to determining the urgency level satisfies a threshold urgency. Additionally or alternatively, in some instances, computing device 300 may determine whether to output a representation of the message based on the risk level for the worker, as described above.

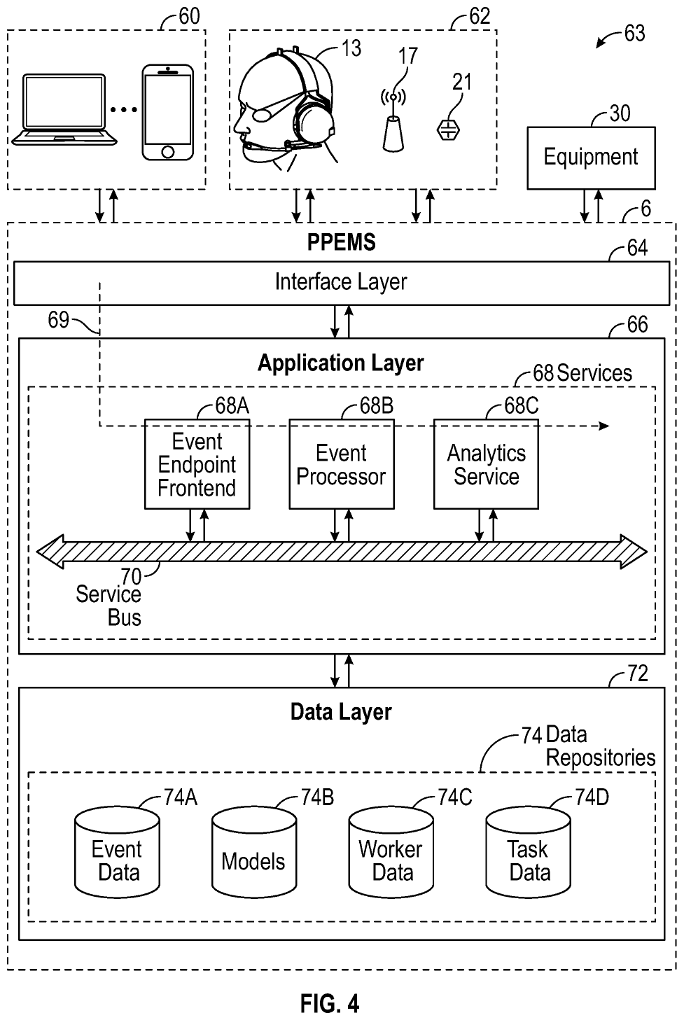

FIG. 4 is a block diagram providing an operating perspective of PPEMS 6 when hosted as cloud-based platform capable of supporting multiple, distinct environments 8 having an overall population of workers 10, in accordance with techniques described herein. In the example of FIG. 4, the components of PPEMS 6 are arranged according to multiple logical layers that implement the techniques of the disclosure. Each layer may be implemented by one or more modules comprised of hardware, software, or a combination of hardware and software.

In FIG. 4, safety equipment 62 include personal protective equipment (PPE) 13, beacons 17, and sensing stations 21. Equipment 30, safety equipment 62, and computing devices 60 operate as clients 63 that communicate with PPEMS 6 via interface layer 64. Computing devices 60 typically execute client software applications, such as desktop applications, mobile applications, and web applications. Computing devices 60 may represent any of computing devices 16, 18 of FIG. 1. Examples of computing devices 60 may include, but are not limited to a portable or mobile computing device (e.g., smartphone, wearable computing device, tablet), laptop computers, desktop computers, smart television platforms, and servers, to name only a few examples.

Client applications executing on computing devices 60 may communicate with PPEMS 6 to send and receive data that is retrieved, stored, generated, and/or otherwise processed by services 68. The client applications executing on computing devices 60 may be implemented for different platforms but include similar or the same functionality. For instance, a client application may be a desktop application compiled to run on a desktop operating system or a mobile application compiled to run on a mobile operating system. As another example, a client application may be a web application such as a web browser that displays web pages received from PPEMS 6. In the example of a web application, PPEMS 6 may receive requests from the web application (e.g., the web browser), process the requests, and send one or more responses back to the web application. In this way, the collection of web pages, the client-side processing web application, and the server-side processing performed by PPEMS 6 collectively provides the functionality to perform techniques of this disclosure. In this way, client applications use various services of PPEMS 6 in accordance with techniques of this disclosure, and the applications may operate within various different computing environment (e.g., embedded circuitry or processor of a PPE, a desktop operating system, mobile operating system, or web browser, to name only a few examples).

In some examples, the client applications executing at computing devices 60 may request and edit event data including analytical data stored at and/or managed by PPEMS 6. In some examples, the client applications may request and display aggregate event data that summarizes or otherwise aggregates numerous individual instances of safety events and corresponding data obtained from safety equipment 62 and/or generated by PPEMS 6. The client applications may interact with PPEMS 6 to query for analytics data about past and predicted safety events, behavior trends of workers 10, to name only a few examples. In some examples, the client applications may output, for display, data received from PPEMS 6 to visualize such data for users of computing devices 60. As further illustrated and described in below, PPEMS 6 may provide data to the client applications, which the client applications output for display in user interfaces.

As shown in FIG. 4, PPEMS 6 includes an interface layer 64 that represents a set of application programming interfaces (API) or protocol interface presented and supported by PPEMS 6. Interface layer 64 initially receives messages from any of computing devices 60 for further processing at PPEMS 6. Interface layer 64 may therefore provide one or more interfaces that are available to client applications executing on computing devices 60. In some examples, the interfaces may be application programming interfaces (APIs) that are accessible over a network. Interface layer 64 may be implemented with one or more web servers. The one or more web servers may receive incoming requests, process and/or forward data from the requests to services 68, and provide one or more responses, based on data received from services 68, to the client application that initially sent the request. In some examples, the one or more web servers that implement interface layer 64 may include a runtime environment to deploy program logic that provides the one or more interfaces. As further described below, each service may provide a group of one or more interfaces that are accessible via interface layer 64.

In some examples, interface layer 64 may provide Representational State Transfer (RESTful) interfaces that use HTTP methods to interact with services and manipulate resources of PPEMS 6. In such examples, services 68 may generate JavaScript Object Notation (JSON) messages that interface layer 64 sends back to the computing devices 60 that submitted the initial request. In some examples, interface layer 64 provides web services using Simple Object Access Protocol (SOAP) to process requests from computing devices 60. In still other examples, interface layer 64 may use Remote Procedure Calls (RPC) to process requests from computing devices 60. Upon receiving a request from a client application to use one or more services 68, interface layer 64 sends the data to application layer 66, which includes services 68.

As shown in FIG. 4, PPEMS 6 also includes an application layer 66 that represents a collection of services for implementing much of the underlying operations of PPEMS 6. Application layer 66 receives data included in requests received from clients 63 and further processes the data according to one or more of services 68 invoked by the requests. Application layer 66 may be implemented as one or more discrete software services executing on one or more application servers, e.g., physical or virtual machines. That is, the application servers provide runtime environments for execution of services 68. In some examples, the functionality interface layer 64 as described above and the functionality of application layer 66 may be implemented at the same server.

Application layer 66 may include one or more separate software services 68, e.g., processes that communicate, e.g., via a logical service bus 70 as one example. Service bus 70 generally represents logical interconnections or set of interfaces that allows different services to send messages to other services, such as by a publish/subscription communication model. For instance, each of services 68 may subscribe to specific types of messages based on criteria set for the respective service. When a service publishes a message of a particular type on service bus 70, other services that subscribe to messages of that type will receive the message. In this way, each of services 68 may communicate data to one another. As another example, services 68 may communicate in point-to-point fashion using sockets or other communication mechanisms. Before describing the functionality of each of services 68, the layers are briefly described herein.

Data layer 72 of PPEMS 6 represents a data repository that provides persistence for data in PPEMS 6 using one or more data repositories 74. A data repository, generally, may be any data structure or software that stores and/or manages data. Examples of data repositories include but are not limited to relational databases, multi-dimensional databases, maps, and hash tables, to name only a few examples. Data layer 72 may be implemented using Relational Database Management System (RDBMS) software to manage data in data repositories 74. The RDBMS software may manage one or more data repositories 74, which may be accessed using Structured Query Language (SQL). Data in the one or more databases may be stored, retrieved, and modified using the RDBMS software. In some examples, data layer 72 may be implemented using an Object Database Management System (ODBMS), Online Analytical Processing (OLAP) database or other suitable data management system.

As shown in FIG. 4, each of services 68A-68C (collectively, services 68) is implemented in a modular form within PPEMS 6. Although shown as separate modules for each service, in some examples the functionality of two or more services may be combined into a single module or component. Each of services 68 may be implemented in software, hardware, or a combination of hardware and software. Moreover, services 68 may be implemented as standalone devices, separate virtual machines or containers, processes, threads or software instructions generally for execution on one or more physical processors. In some examples, one or more of services 68 may each provide one or more interfaces that are exposed through interface layer 64. Accordingly, client applications of computing devices 60 may call one or more interfaces of one or more of services 68 to perform techniques of this disclosure.

Event endpoint frontend 68A operates as a frontend interface for exchanging communications with equipment 30 and safety equipment 62. In other words, event endpoint frontend 68A operates to as a frontline interface to equipment deployed within environments 8 and utilized by workers 10. In some instances, event endpoint frontend 68A may be implemented as a plurality of tasks or jobs spawned to receive individual inbound communications of event streams 69 that include data sensed and captured by equipment 30 and safety equipment 62. For instance, event streams 69 may include message from workers 10 and/or from equipment 30. Event streams 69 may include sensor data, such as PPE sensor data from one or more PPE 13 and environmental data from one or more sensing stations 21. When receiving event streams 69, for example, event endpoint frontend 68A may spawn tasks to quickly enqueue an inbound communication, referred to as an event, and close the communication session, thereby providing high-speed processing and scalability. Each incoming communication may, for example, carry messages from workers 10, remote users 24 of computing devices 60, or captured data (e.g., sensor data) representing sensed conditions, motions, temperatures, actions or other data, generally referred to as events. Communications exchanged between the event endpoint frontend 68A and safety equipment 62, equipment 30, and/or computing devices 60 may be real-time or pseudo real-time depending on communication delays and continuity.

In general, event processor 68B operates on the incoming streams of events to update event data 74A within data repositories 74. In general, event data 74A may include all or a subset of data generated by safety equipment 62 or equipment 30. For example, in some instances, event data 74A may include entire streams of data obtained from PPE 13, sensing stations 21, or equipment 30. In other instances, event data 74A may include a subset of such data, e.g., associated with a particular time period. Event processor 68B may create, read, update, and delete event data stored in event data 74A.

In accordance with techniques of this disclosure, in some examples, analytics service 68C is configured to manage messages presented to workers in a work environment while the workers are utilizing PPE 13. Analytics service 68C may include all or a portion of the functionality of PPEMS 6 of FIG. 1, computing devices 38 of FIG. 1, and/or computing device 300 of FIG. 3. Analytics service 68C may determine whether to cause an article of PPE 13 utilized by a first worker to output a representation of audio data received from a second worker. For example, PPEMS 6 may receive an indication of audio data that includes a message from worker 10A of FIG. 1. In some instances, the indication of the audio data includes an analog signal that includes the audio data. In another instance, the indication of the audio data includes a digital signal encoded with the audio data. In yet another instance, the indication of the audio data includes text indicative of the message.

Analytics service 68C may determine whether to output a representation of the message included in the audio data based on one or more rules. The rules may be pre-programmed or generated using machine learning. In the example of FIG. 4, the rules are stored in models 74B. Models 74B include, in some example, separate models for individual workers, a population of workers, a particular environment, a type of PPE, a type task, or combinations thereof. Analytics service 68C may update models 74B as PPEMS 6 receives additional data, such as data received from safety equipment 62, equipment 30, or both.

In some examples, analytics service 68C determines a risk level for the worker based on one or more models 74B. For example, analytics service 68C may apply one or more models 74B to event data 74A (e.g., sensor data), worker data 74C, task data 74D, or a combination thereof to determine a risk level for worker 10A.

Analytics service 68C may determine an urgency level for the message based on one or more models 74B. For example, analytics service 68C may apply one or more models 74B to audio characteristics for the audio data, content of the message, metadata for the message, or a combination thereof.

In some scenarios, analytics service 68C determines whether to output a representation of the message based at least in part on the risk level for worker 10A, an urgency level of the received message, or both. For example, analytics service 68C may determine whether to output a visual representation of the message based on the risk level and/or urgency level. In another example, analytics service 68C determines whether to output an audible representation of the message based on the risk level and/or urgency level. In some instances, analytics service 68C determines whether to output a visual representation of the message, an audible representation of the message, both an audible representation and a visual representation of the message, or none at all.

Responsive to determining to output a visual representation of the message, analytics service 68C may output data causing display device 34A of PPE 13A to output the visual representation of the message by outputting a GUI. The GUI may include that text or an image (e.g., icon, emoji, GIF, etc.) indicative of the message. Similarly, analytics service 68C may output data causing speakers 32A of PPE 13A to output an audible representation of the message.

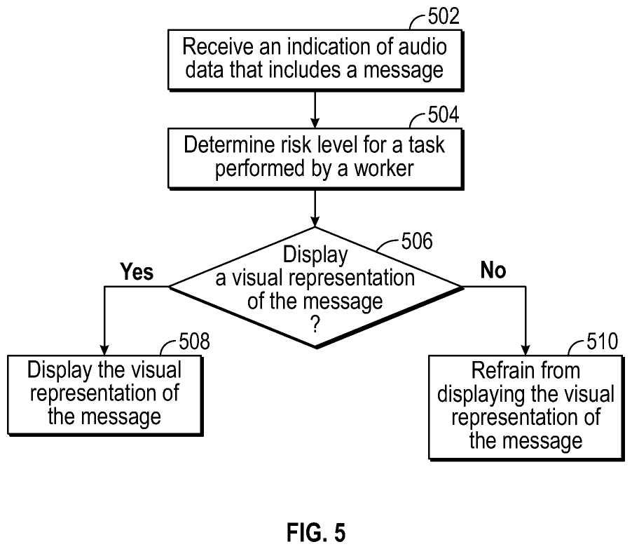

FIG. 5 is a flowchart illustrating example operations of an example computing system, in accordance with various techniques of this disclosure. FIG. 5 is described below in the context of computing device 38B of PPE 13B worn by worker 10B of FIG. 1. While described in the context of computing device 38B of PPE 13B, other computing devices (e.g., computing device 38A of FIG. 1; PPEMS 6 of FIGS. 1, 4; computing devices 16, 18 of FIG. 1; computing device 300 of FIG. 3) may perform all or a subset of the functionality described.

Computing device 38B receives an indication of audio data that includes a message (502). Computing device 38B may receive the indication of the audio data from another computing device, such as a computing device 38A associated with another worker 10A, PPEMS 6, computing devices 16, 18, or any other computing device. The indication of the audio data may include an analog signal that includes the audio data. The indication of the audio data may include a digital signal encoded with the audio data. In some instances, the indication of the audio data includes text indicative of the message.

In some examples, computing device 38B determines a risk level for worker 10B (504). In some examples, computing device 38B determines the risk level based on task data associated with a task performed by worker 10B, worker data associated with worker 10B, sensor data (e.g., environmental data generated by one or more environmental sensors and/or physiological data generated by one or more physiological sensors associated with worker 10B), or a combination thereof. In some examples, computing device 38B determines the risk level by applying one or more models (e.g., generated by machine learning) to the task data, worker data, and/or sensor data.

Computing device 38B may determine whether to output a visual representation of the message (506) based at least in part on the risk level for worker 10B. For example, computing device 38B may compare the risk level to a threshold risk level. In some instances, computing device 38B determines whether to output the visual representation of the message based on the risk level for worker 10B and an urgency level of the message.

Responsive to determining to output the visual representation of the message (“YES” branch of 506), in some examples, computing device 38B outputs a visual representation of the message (508). For example, computing device 38B may output the visual representation of the message by outputting a GUI via a display device of PPE 13B. The visual representation of the message may include text, an image (e.g., an icon, emoji, map, GIF, etc.), or both.

In some examples, computing device 38B refrains from outputting a visual representation of the message (510) in response to determining not to output the visual representation of the message (“NO” branch of 510). In some examples, computing device 38B may output an audible representation of the message rather than a visual representation of the message. As another example, computing device 38B may refrain from outputting a visual or audible representation of the message.

The following numbered examples may illustrate one or more aspects of the disclosure:

Example 1. A method comprising: receiving, by a computing device, an indication of audio data from a second worker, the audio data including a message; determining, by the computing device, a risk level for a first worker utilizing an article of personal protective equipment; determining, by the computing device, based at least in part on the risk level, whether to display a visual representation of the message; and responsive to determining to display the visual representation of the message, outputting, by the computing device, for display by a display device of the article of PPE, the visual representation of the message.

Example 2: The method of example 1, wherein determining the risk level is based at least in part on one or more physiological conditions of the worker.

Example 3: The method of any one of examples 1-2, wherein determining the risk level is further based at least in part on task data for a task associated with the first worker, wherein the task data includes at least one of: a location of the task, a complexity of the task, a severity of harm to the first worker, a likelihood of harm to the first worker, a type of the task, or a duration of the task.

Example 4: The method of any one of examples 1-3, wherein the visual representation comprises one or more of text or an image.

Example 5: The method of any one of examples 1-4, further comprising: determining, by the computing device, an urgency level of the message; and determining, by the computing device, whether to display the visual representation of the message further based on an urgency level of the message.

Example 6: The method of example 5, wherein determining the urgency level is based on one or more audio characteristics of the audio data.

Example 7: The method of any one of examples 5-6, wherein determining the urgency level is based on content of the message.

Example 8. The method of any one of examples 5-7, wherein determining the urgency level is based on metadata for the message.

Example 9. The method of any one of examples 1-8, further comprising: determining, by the computing device, whether to output an audible representation of the message.

Example 10. The method of any one of examples 1-9, wherein the message indicates a task associated with another worker, the method further comprising: outputting, by the computing device, for display by the display device, data associated with the message, wherein the data associated with the message includes one or more of: a map indicating a location of the task; one or more articles of PPE associated with the task; or one or more articles of equipment associated with the task.

Example 11. The method of any one of examples 1-10, wherein the message is a first message, the method further comprising: receiving, by the computing device, a second message from an article of equipment within a work environment that includes the first worker; and determining, by the computing device whether to output a representation of the second message.

Although the methods and systems of the present disclosure have been described with reference to specific exemplary embodiments, those of ordinary skill in the art will readily appreciate that changes and modifications may be made thereto without departing from the spirit and scope of the present disclosure.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

1. A system, comprising:
a plurality of articles of personal protective equipment (PPE) connected to form a network of articles of PPE, wherein each article of PPE is associated with a worker and wherein each article of PPE includes memory and one or more processors, wherein the memory of each article of PPE includes instructions that, when executed by the one or more processors, cause the respective article of PPE to:
receive one or more first safety issue notifications from the network;
share the first safety issue notifications with the worker associated with the article of PPE via an output of the article of PPE;
receive safety-related information at an input of the article of PPE;
create a second safety issue notification based on the safety-related information received at the input of the article of PPE;
select one or more of the other articles of PPE to receive the second safety issue notification; and
transmit the second safety issue notification over the network to the selected articles of PPE.

2. The system of claim 1, wherein the system further includes a social safety platform connected via the network to the plurality of articles of PPE,
wherein the social safety platform observes incidents and events in the work environment and automatically generates safety issue notifications based on the observations.

3. The system of claim 1, wherein the system further includes a social safety platform connected via the network to the plurality of articles of PPE,
wherein the social safety platform observes incidents and events in the work environment and automatically generates tailored safety issue notifications to workers and safety management based on the observations.

4. An article of personal protective equipment (PPE), comprising:
input;
output;
a network interface;
memory; and
one or more processors connected to the input, the output, the network interface and the memory, wherein the memory includes instructions that, when executed by the one or more processors, cause the processors to:
receive one or more first safety issue notifications on the network interface;
share the first safety issue notifications with the worker associated with the article of PPE via an output of the article of PPE;
receive safety-related information at an input of the article of PPE;
create a second safety issue notification based on the safety-related information received at the input of the article of PPE;
select one or more other articles of PPE to receive the second safety issue notification; and
transmit the second safety issue notification via the network interface to the selected articles of PPE.

5. The article of PPE of claim 4, wherein the safety issue notifications include basic safety messages.

6. The article of PPE of claim 4, wherein the output is a speaker and wherein the processors share the first safety issue notifications with the worker associated with the article of PPE via the speaker.

7. The article of PPE of claim 4, wherein the output is a display and wherein the processors share the first safety issue notifications with the worker associated with the article of PPE by displaying the first safety issue notifications within a user interface of the display.

8. The article of PPE of claim 7, wherein the user interface displays information on one or more of the received first safety issue notification in a first section of the user display and wherein the user interface displays communications received from other workers in a second section of the user interface.

9. The article of PPE of claim 8, wherein the processors blank or otherwise obscure information in the second section of the user interface when necessary to avoid distracting the worker associated with the article of PPE.

10. The article of PPE of claim 8, wherein each first safety issue notification has a level of criticality, and
wherein the processors queue up first safety issue notifications below a predefined level of criticality to avoid distracting the worker associated with the article of PPE.

11. The article of PPE of claim 8, wherein each first safety issue notification has a level of criticality, and
wherein the processors queue up first safety issue notifications when the level of criticality of the first safety issue notification falls below a level of criticality assigned to the worker associated with the article of PPE based on the task being performed by the worker.

12. The article of PPE of claim 4, wherein the input is one or more buttons and wherein the processors receive the safety-related information as a sequence of button presses.

13. The article of PPE of claim 4, wherein the input is a microphone and wherein the processors receive the safety-related information as sound captured by the microphone.

14. The article of PPE of claim 4, wherein the article of PPE further includes a communication channel configured to be connected to a piece of equipment, wherein, when connected, the processors establish two-way communication between the article of PPE and the piece of equipment via the communications channel.

15. In a network of connected articles of personal protective equipment (PPE), wherein the articles of PPE include a first article of PPE, a method comprising:
receiving, at the first article of PPE and via the network, one or more first safety issue notifications;
sharing the first safety issue notifications with a worker associated with the first article of PPE via an output of the first article of PPE;
receiving safety-related information at an input of the first article of PPE;
creating a second safety issue notification based on the safety-related information received at the input of the first article of PPE;
selecting one or more articles of PPE to receive the second safety issue notification; and
transmitting the second safety issue notification via the network from the first PPE to the selected articles of PPE.

16. The method of claim 15, wherein each safety issue notification is one or more of a safety alert and a safety issue notification, wherein each safety alert is a safety critical notification and each safety issue notification is limited to information that is not safety critical.

17. The method of claim 15, wherein the first article of PPE is connected through a communication channel to a piece of equipment, wherein the method further comprises:
receiving, at the first article of PPE and via the network, one or more configuration notifications, wherein each configuration notification includes configuration information used to configure one or more of the piece of equipment and the first article of PPE.

18. The method of claim 15, wherein receiving safety-related information at an input of the first article of PPE includes receiving a request to forward a selected one of the received first safety issue notifications, and
wherein transmitting the second safety issue notification includes transmitting the selected one of the received first safety issue notifications to the selected articles of PPE.

19. The method of claim 15, wherein the network includes a social safety platform connected to the articles of PPE,
wherein receiving safety-related information at an input of the first article of PPE includes receiving a request to forward a selected one of the received first safety issue notifications, and
wherein transmitting the second safety issue notification includes transmitting the selected one of the received first safety issue notifications to the social safety platform.

20. The method of claim 15, wherein receiving safety-related information at an input of the first article of PPE includes receiving a tag via the input, the tag associated with a selected one of the received first safety issue notifications.

21-36. (canceled)
